(19) United States
(12) Patent Application Publication
(10) Pub. No.: US 2006/0089573 A1
(43) Pub. Date: Apr. 27, 2006

(54) Massage device

(76) Inventor: Dong Rae Park, Farmers Branch, TX (US)

Correspondence Address: CARSTENS & CAHOON, LLP, P O BOX 802334, DALLAS, TX, 75380, US

(21) Appl. No.: 10/970,087

(22) Filed: Oct. 21, 2004

(51) Int. Cl. A61H 7/00

(52) U.S. Cl. 601/15; 601/98; 601/101; 601/103

(57) ABSTRACT

The present invention provides a massage device. The invention includes a table with an attached cross beam at a specified height above the table surface. The position of the cross beam may be adjusted along the length of the table. The cross beam may also be swung open on a hinge, allowing easier patient mounting and dismounting from the table. Mounted to the cross beam is a motorized unit that can be positioned along the length of the cross beam. The height of the motorized unit over the table may also be adjusted. The motorized unit has a moving contact surface that performs the actual massaging action by moving horizontally on the skin of the person lying on the table. The contact surface of the motorized unit may be a flat pad. In an alternate embodiment of the invention, the contact surface of the motorized unit has a plurality of nodules that act ac focused contact points that may be electrically heated.

### BACKGROUND OF THE INVENTION

1. Technical Field

The present invention relates generally to a massage device, and more specifically to a table mounted motorized massage device.

2. Description of Related Art

Massage is one of the oldest forms of physical therapy in existence. From Swedish massage to Japanese shiatsu, massage has assumed many variations across many cultures. Massage is a system of stroking, pressing and kneading different areas of the body to relieve pain, and relax and stimulate the soft tissues (i.e. muscles, fascia, tendons, and ligaments). Massage can improve blood circulation and assists the lymphatic system, improving the elimination of waste throughout the body. Regular massage may also alter chronic muscle tension through effects on autonomic reflexes (i.e. muscle spindles and Golgi tendon organ) and by the release of restrictions and adhesions within the fascia surrounding the muscle.

While massage therapy is relaxing for the patient, it is often very hard work for the therapist, depending on the technique(s) used and the amount of work that has to be performed on a specific area. Many devices have been developed over the years to meet the physical demands of massage in order to reduce the strain on the therapist. However, many of these devices are simplistic in their design and provide only limited capabilities.

Most conventional massagers have a contact point that moves vertically or simply vibrates. While percussion and vibration are valuable massage techniques, many massage techniques (e.g., kneading and effleurage) require a more horizontal application of force.

Some massages do move horizontally but do so using rollers. With a roller, the contact point continually changes as the device rolls over the skin. However, many massage techniques, particularly effleurage (stroking) and myofascial release, are more effective when a single contact point maintains contact with the skin as force is applied, allowing tissue to be displaced and manipulated more thoroughly.

Additionally, almost all of the massagers are hand held, some devices being fairly heavy. While these hand held devices are ideally intended to reduce the strain and wear and tear on the massage therapist, because of their weight many of them require almost as much work and exertion to use as the traditional hands on techniques.

Therefore, it would be desirable to have a massage device that can perform traditional massage techniques by moving horizontally over a patient's skin with a constant contact surface. It would also be desirable for the massage device to mounted on a piece of furniture, such as a massage table or chair, to reduce the physical exertion necessary to operate the device.

### SUMMARY OF THE INVENTION

The present invention provides a massage device. The invention includes a table with an attached cross beam at a specified height above the table surface. The position of the cross beam may be adjusted along the length of the table. The cross beam may also be swung open on a hinge, allowing easier patient mounting and dismounting from the table. Mounted to the cross beam is a motorized unit that can be positioned along the length of the cross beam. The height of the motorized unit over the table may also be adjusted. The motorized unit has a moving contact surface that performs the actual massaging action by moving horizontally on the skin of the person lying on the table. The speed, force and range of movement of the contact surface are all adjustable, depending on the needs of the patient.

The contact surface of the motorized unit may be a flat pad. In an alternate embodiment of the invention, the contact surface of the motorized unit has a plurality of nodules that act ac focused contact points that may be electrically heated.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A is a perspective view of a massage table with an automated massage device in accordance with the present invention;

FIG. 1B is an end on view of the massage table and illustrates how the cross beam is hinged to allow the patient to get into and out of position under the massager;

FIG. 2A is a perspective view of the bottom of the massager 110 depicted in FIGS. 1A and 1B; and

FIG. 2B shows an alternate embodiment of the massager.

### DETAILED DESCRIPTION OF THE INVENTION

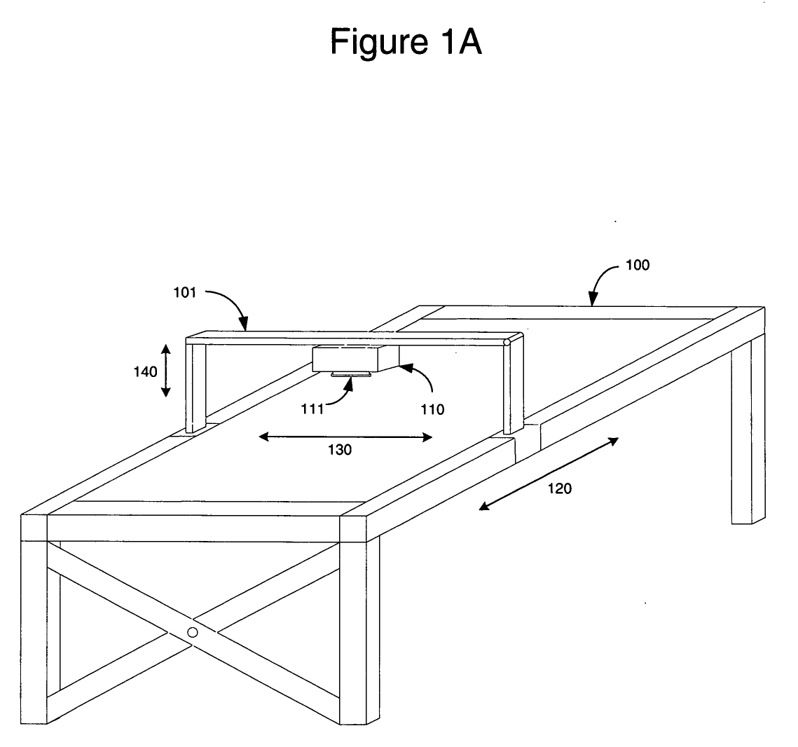

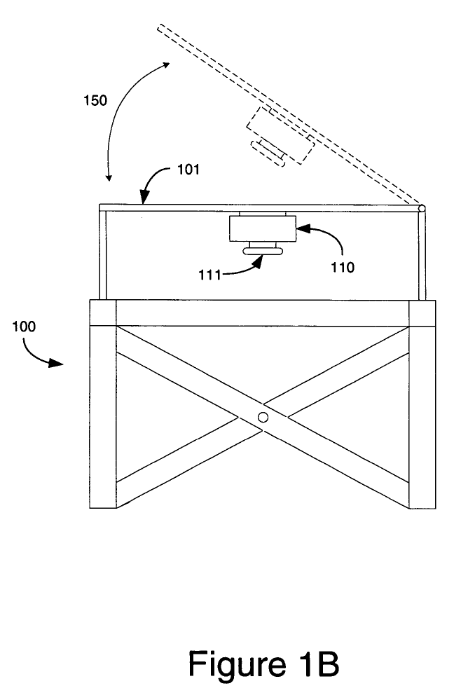

FIG. 1A is a perspective view of a massage table with an automated massage device in accordance with the present invention. The table 100 has a mounted cross beam 101 that can be moved along the length of the table, as indicated by arrow 120. Mounted to the cross beam 101 is a motorized massager 110. The massager 110 in turn has a moving massage pad 111 that serves as the contact surface of the massager and delivers the mechanical force to the patient's skin. The massager 110 is adjustable horizontally along the cross beam 101 as indicated by arrow 130, as well as vertically as indicated by arrow 140.

Because the massager 110 is adjustable along the length and width of the massage table 100, it can be positioned over any part of the patient's body. Vertical adjustment of the massager 110 also allows the massager to be adjusted to the contours of the patient's body, providing a more efficient application of force.

FIG. 1B is an end on view of the massage table 100 and illustrates how the cross beam 101 is hinged to allow the patient to get into and out of position under the massager 110. The cross beam 101 is simply swung upward as illustrated by arrow 150 to allow the patient to position himself or herself on the table without interference from the cross beam 101 or massager 110.

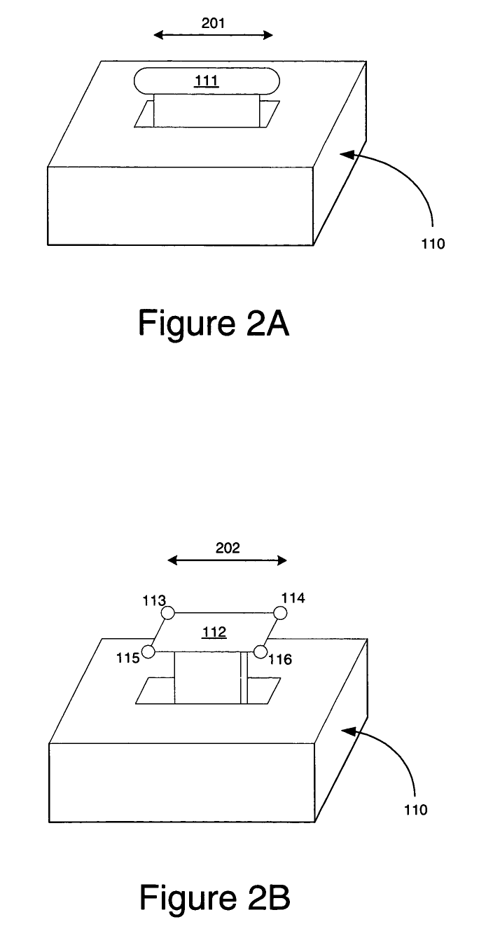

FIG. 2A is a perspective view of the bottom of the massager 110 depicted in FIGS. 1A and 1B. The massager 110 moves a motorized contact pad 111 back and forth, as shown by arrow 201. Unlike rollers used on other massage devices, the motorized pad 111 on the present invention glides horizontally along the patient's skin. The degree of friction on the skin can be adjusted by the use of massage oils or other lubricant.

The pressure applied to the skin may also be adjusted. For example, typical massage applications may utilize five to 25 pound of pressure. However, greater or lesser amounts or force may be used, depending on the specific application. In addition, the range of motion of the motorized pad 111 can be adjusted to produce greater or lesser degrees of displacement with each stroke.

The speed of the motorized pad 111 may also be adjusted, allowing for different responses in the tissue. For example, faster strokes can be used to increase muscle heat and tone, whereas slower strokes may be used to reduce muscle tone, depending on the needs of the patient.

FIG. 2B shows an alternate embodiment of the massager. The basic features are the same as the embodiment shown in FIG. 2A, but the features of the contact pad 112 are different. Whereas the pad 111 on the first embodiment provides a broad contact surface over which the mechanical force is distributed, the alternate pad 112 has four contact nodes 113-116. These nodes 113-116 provide a more concentrated application of mechanical force to the patient, which allows work on deeper layers of soft tissue as well as more focused spots such as trigger points (localized spasm). In addition, the nodes 113-116 can be electrically heated.

The present invention can be applied to a variety of soft tissue work including general massage, myofascial release, and musculoskeletal alignment/manipulation. Thus a relatively simple design can provide the therapist with a wide range of capabilities. This allows the therapist to perform a range of services while reducing the strain and fatigue imposed on the therapist.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

I claim:

1. A massage device, comprising:
a table;
a crossbeam attached to said table at a specified height above the table surface, wherein the position of the cross beam may be adjusted along the length of the table;
a motorized unit mounted to said cross beam, wherein the position of the motorized unit may be adjusted along the length of the cross beam, and wherein the height of the motorized unit over the table may be adjusted; and
wherein the motorized unit has a moving contact surface that performs a massaging action by moving horizontally on the skin of a person on the table.

2. The massage device according to claim 1, wherein the contact surface of the motorized unit is a flat pad.

3. The massage device according to claim 1, wherein the contact surface of the motorized unit has a plurality of focused contact points.

4. The massage device according to claim 3, wherein the said plurality of contact points are electrically heated.

5. The massage device according to claim 1, wherein the force delivered by said moving contact surface may be adjusted.

6. The massage device according to claim 1, wherein the speed of said moving contact surface may be adjusted.

7. The massage device according to claim 1, wherein the range of movement of said moving contact surface may be adjusted.

8. The massage device according to claim 1, wherein the crossbeam can be swung on a hinge away from the table.
